(19) United States
(12) Patent Application Publication
(10) Pub. No.: US 2024/0250334 A1
(43) Pub. Date: Jul. 25, 2024

(54) THERMAL RUNAWAY SUPPRESSION SHEET AND BATTERY PACK AND/OR BATTERY MODULE USING THE SAME

(71) Applicant: IMAE INDUSTRY CO., LTD., Osaka (JP)

(72) Inventors: Kenji IMAE, Osaka (JP); Yoshihiko IMAE, Osaka (JP); Takashi SHIRAI, Osaka (JP); Tetsuro ARAI, Osaka (JP)

(73) Assignee: IMAE INDUSTRY CO., LTD., Osaka (JP)

(21) Appl. No.: 18/593,084

(22) Filed: Mar. 1, 2024

Related U.S. Application Data
(63) Continuation of application No. PCT/JP2023/004680, filed on Feb. 13, 2023.

(30) Foreign Application Priority Data
Feb. 15, 2022 (JP) 2022-021093
Jul. 5, 2022 (JP) 2022-108304

(51) Int. Cl. H01M 10/653; H01M 10/6551; H01M 50/213

(52) U.S. Cl. CPC H01M 10/653; H01M 10/6551; H01M 50/213

(57) ABSTRACT

Provided are a thermal runaway suppression sheet with maximum thickness of 3 mm or less and capable of insulating to temperature at which a propagation of thermal runaway in a lithium ion battery can be suppressed, and a battery pack and a battery module. The thermal runaway suppression sheet includes a thermal energy consumption layer containing a silica-based inorganic fiber having a hydroxyl group, and a thermal diffusion layer having a thermal conductivity in the planar direction that is 10 to 200 times as high as the thermal conductivity in the thickness direction. The thermal runaway suppression sheet has a thickness of 3 mm or less. When the thermal runaway suppression sheet is locally heated, the thermal energy consumption effect based on the silica-based inorganic fibers contained in the thermal energy consumption layer can be efficiently utilized by the thermal conduction along the planar direction of the thermal diffusion layer.

### CLAIM FOR PRIORITY

This application is a Continuation of PCT/JP2023/004680 filed Feb. 13, 2023, and claims the priority benefit of Japanese patent application 2022-021093 filed Feb. 15, 2022, and 2022-108304 filed Jul. 5, 2022, the contents of which are expressly incorporated by reference herein in their entireties.

### TECHNICAL FIELD

The present invention relates to a thermal runaway suppression sheet positioned between cells in a battery used as a power for battery electric vehicle or hybrid electric vehicle, or between cells in a battery pack, and used as an industrial or household storage battery, and so on, as well as a thermal runaway suppression sheet that can be used for thermal insulation of a housing for a battery pack and/or battery module that contains a plurality of cells. The present invention also relates to a battery pack and/or battery module using the thermal runaway suppression sheet.

### BACKGROUND

A battery electric vehicle or a hybrid electric vehicle driven by an electric motor is equipped with a battery pack in which cells are connected in series or in parallel, as a power source therefore. Battery electric vehicles are also equipped with a battery pack containing a plurality of batteries in a housing, and in some cases, stacked battery modules. A lithium ion secondary battery having a high capacity and providing a high output is mainly used as the battery cell.

In the case that a temperature of one of the battery cells rapidly rises due to a short circuit or overcharge, a thermal runaway occurs and fire from the cell under the thermal runaway spreads to adjacent cells. The propagation of the thermal runaway to neighboring cells within a battery module may threaten serious events such as explosion.

In order to reduce the risk associated with thermal runaway, it is proposed to provide a thermal runaway suppression sheet between battery cells. The sheet may mitigate the propagation of thermal runway. In addition, in order to manage a thermal runaway caused from an overheated or fired battery module and in order that the thermal runaway does not affect the neighboring modules, there is a proposal that the modules are thermally insulated by the thermal runaway suppression sheet.

FIG. 1 shows an exemplary design of a battery module containing an array consisting of cells 1 in a housing 2. In this example, a thermal runaway suppression sheet 3 is placed between the battery cells 1. Also, a thermal runaway suppression sheet 3 may be placed between the housing 2 and the battery cell 1 for insulation.

By the use of the thermal runaway suppression sheet 3 in a battery module, even if one of the cells in the battery module undergoes thermal runaway, the sheet 3 adjacent to the cell would insulate heat transfer and shield flame to neighboring cells. This can protect battery cells from the exposure to flame or refrain from trigger of thermal runaway of the neighboring cell, which results in preventing the propagation of thermal runaway.

As a thermal runaway suppression sheet used for such purposes, for example, Patent Document 1 (JP6885791B) proposes a laminate-type thermal runaway suppression sheet comprising an endothermic material layer and a fire-resistant thermal insulation layer. The endothermic material layer contains a matrix resin selected from thermosetting resins, thermoplastic elastomers, and rubbers, and at least one from mineral powder and a flame retardant which are embedded in the matrix. The fire-resistant thermal insulation layer is composed of metal foil or metal foil-laminated inorganic fiber cloth (e.g., aluminum foil-laminated glass cloth, copper foil-laminated glass cloth).

In addition, JP2021-531631A (Patent Document 2) suggests a sheet made by papermaking technique of a combustion-resistant insulating material. The insulating material comprises two types of glass fibers having a different diameter from each other, a particulate filler mixture of at least two selected from glass bubbles, kaolin clay, talc, mica, calcium carbonate and alumina trihydrate, and an inorganic binder.

WO2019/187313 (Patent Document 3) also suggests a thermal insulating sheet used by being placed between the stacked surfaces of the battery cells in a battery pack (battery block) in which multiple battery cells are fixed in a stacked state. The thermal insulating sheet was produced as follows: preparing a slurry for making a paper by mixing 10% by weight of glass fiber and 10% by weight of nylon fiber with 80% by weight of magnesium silicate (sepiolite), and undergoing papermaking with the slurry to obtain a sheet, followed by drying and hot-pressing to produce an inorganic fiber sheet with a thickness of 0.7 mm. Thus manufactured inorganic fiber sheet is sandwiched by polyethylene films (thickness of 50 μm) via adhesive to obtain a thermal insulating sheet.

Disclosed is that the thermal insulating sheet could prevent thermal runaway from spreading an adjacent battery in a battery block (Example 1). However, there is no disclosure how to evaluate the prevention of thermal runaway.

JP2021-034278A (Patent Document 4) suggests a thermal insulating sheet for a battery pack obtained from a papermaking slurry. The slurry is prepared by dispersing two types of inorganic particles comprising of silica nanoparticles as a first particle and a metal oxide particle such as titania and alumina as a second particle, and a binder containing glass fibers, pulp fibers or a polymer flocculant, in water. Examples show that the combination of silica nanoparticle and titania particle enhanced an insulating performance as compared with a combination of inorganic particles including silica aerogel or aluminum hydroxide.

JP6997263B and JP7000508B (Patent Documents 5 and 6) suggests a thermal transfer suppressing sheet containing two types of inorganic fibers and an inorganic particle capable of providing a thermal insulating effect. The inorganic particle includes an oxide particle such as alumina and titania, and a porous or hollow particle with high porosity. In the former patent document, a combination of a linear fiber and a crimped fiber are used as said two types of inorganic fibers. While, in the latter document, a combination of fibers differing in diameter and length are used as said two types of inorganic fibers. The documents describe that the fibers in those combinations are entangled to hold the inorganic particles stably even at an amount of 30 to 90% by weight, and the thermal transfer suppressing sheet could retain the shape during a thermal runaway occurred at high temperatures. However, these documents fail to disclose a specific kind or type concerning the first and second inorganic fibers, and there are no specific examples demonstrating to prevent powder from falling off.

In addition, WO2021/256093 (Patent Document 7) suggests a thermal insulating sheet comprising a first sheet having a thermal conductivity of 1.00 W/m·K or more in the thickness direction and a second sheet having a thermal conductivity of 0.50 W/m·K or less in the thickness direction, wherein the first sheet is used as an intermediate layer sandwiched between the second sheets.

An exemplary thermal insulating sheet comprises an intermediate layer of an aluminum foil or a graphite powder-containing sheet; and sheets (surface layers) each being made from a slurry containing micro glass fiber, pulp, silicate mineral powder, and rubber resin (NBR) as a binder and being laminated on both sides of the intermediate layer. It is disclosed that the exemplary thermal insulating sheet exhibited a higher insulating performance than a thermal insulating sheet without the intermediate layer.

### PRIOR ART

### Patent Document

Patent Document 1: JP6885791 B
Patent Document 2: JP2021-531631A
Patent Document 3: WO2019/187313
Patent Document 4: JP2021-034278A
Patent Document 5: JP6997263B
Patent Document 6: JP7000508B
Patent Document 7: WO2021/256093

### SUMMARY OF THE INVENTION

### Technical Problem to be Solved by the Invention

The thermal runaway suppression sheet suggested in the Patent Document 1 was evaluated by a test in which one side of the sheet is heated at 400° C. for 10 minutes.

A thermal runaway suppression sheet used for a battery for a motor in an electric vehicle such as battery electric vehicle and hybrid electric vehicle are required to withstand firing at a high temperature around 1000° C. for about 10 minutes. Under a critical condition with high temperatures, the matrix resin in the endothermic material layer would be molten or carbonized by absorbing the thermal energy caused from thermal runaway. This means that the matrix cannot keep the endothermic material such as mineral powder and the flame retardant therein. The matrix resin may impair the fire resistance of the thermal runaway suppression sheet when fired.

Patent Document 2 disclosed in Example that the insulation sheet containing from 7 to 25% by weight of glass fiber and further containing clay, mica, and glass bubbles could withstand an evaluation test in which the insulation sheet is exposed to torch flame.

In the Example, the test was conducted with respect to a multi-layered sheet or board prepared by laminating plural sheets with sodium silicate as an inorganic binder, pressurizing and drying. A thin sheet was punctured under the evaluation test.

The inorganic fiber sheet suggested in the Patent Document 3 has a main body containing 80% by weight of magnesium silicate (sepiolite). Sepiolite, which is called as a mineral fiber, generally corresponds to a fibrous mineral particle with a length of several μm, or at most several tens of μm, and thus the sheet is powdery. For this reason, there is a room for improvement in terms of handling of the inorganic sheet.

In the thermal runaway suppression sheets proposed in Patent Documents 4 through 6, an inorganic particle as an ingredient of the sheet has a role of insulating thermal energy caused from the thermal runaway, in other words, the inorganic particle prevents and suppresses the thermal runaway propagation to an adjacent cell. Therefore, an increase in a content rate or a quantity of the inorganic particles can enhance the thermal insulating performance. However, an increase in quantity of inorganic particles trades off for the decrease in quantity of inorganic fibers which are used for retaining the particles in the sheet. On the other hand, increases in both quantities of inorganic particles and inorganic fibers make the thermal runaway suppression sheet thicker.

With respect to a battery module set as a power for an electric motor such as battery powered electric vehicle or hybrid electric vehicle, there is a strong demand for lightweight and reduced size. In this connection, an acceptable thickness of the thermal runaway suppression sheet for this application, is at most 3 mm, preferably 2 mm or less, more preferably 1.8 mm or less, and preferably 1.6 mm or less.

The thermal insulating sheets disclosed in Examples of Patent Document 7 had a thickness of 1.6 mm or less. The combustion test was conducted by heating the sheet at 600° C.

Under these situations, the purpose of the invention is to provide a thermal runaway suppression sheet capable of decreasing a temperature down to less than 400° C., preferably less than 300° C., when exposed to a high temperature around 1000° C. or to a flame, thereby reducing the risk of thermal runaway propagation. And the thermal runaway suppression sheet has a thickness of at most 3 mm and does not contain inorganic particles (e.g., flame retardant and porous inorganic particle) inducing an issue of powder falling off.

### Means for Solving the Problem

The thermal runaway suppression sheet of the present invention comprises a thermal energy consumption layer composed of a sheet made of silica-based inorganic fiber having a hydroxyl group, and a thermal diffusion layer having a thermal conductivity in the planar direction that is from 10 to 200 times as high as the thermal conductivity in the thickness direction. The thickness of the thermal runaway suppression sheet is 3 mm or less.

In one embodiment, the thermal diffusion layer is a sheet or coating layer containing an expanded graphite or boron nitride as a main component.

In another embodiment of the present invention, the silica-based inorganic fiber sheet is preferably woven fabric, nonwoven fabric, or paper with a thickness of 0.1 to 2.0 mm. The amount of the silica-based inorganic fiber contained in the silica-based inorganic fiber sheet is preferably from 100 kg/m³ to 400 kg/m³.

In the case of the silica-based inorganic fiber sheet in the form of nonwoven fabric or paper, a sheet having a thickness of 0.1 to 1.5 mm and made from a silica-based inorganic fiber or staple fiber via papermaking process is preferred. The nonwoven fabric or paper may contain the silica-based inorganic fiber in a content of 50 to 80% by weight, and glass fiber in a content of 2 to 20% by weight, and an organic fiber in a content of 3 to 15% by weight, and optionally may contain a fibrous mineral.

In another embodiment, the thermal energy consumption layer has a bulk density of 150 to 400 kg/M³.

According to another aspect of the disclosure, a silica-based inorganic fiber sheet comprises from 50 to 80% by weight of a silica-based inorganic fiber which can generate water by condensation reaction, from 2 to 20% by weight of a glass fiber, and from 3 to 15% by weight of an organic fiber, and optionally comprising from 10 to 40% by weight of a fibrous mineral.

The present invention also includes a battery pack and a battery module each of which contains a disclosed thermal runaway suppression sheet. That is, the battery pack or the battery module comprises a plurality of cells connected in series or in parallel and housed in a housing, wherein the thermal runaway suppression sheet of the invention is positioned between the battery cells, or wherein the thermal runaway suppression sheet of the invention is attached to an inner wall surface of the housing.

### Effect of the Invention

The thermal runaway suppression sheet of the present invention can exhibit an excellent thermal insulating performance regardless of a thin sheet. Because the silica-based inorganic fiber having hydroxyl groups in the thermal energy consumption layer consume thermal energy caused from thermal runaway, and moreover, the thermal diffusion layer may effectively enhance a thermal energy consumption when the thermal energy consumption layer undergoes a localized firing or exothermic reaction. Therefore, even if a certain cell undergoes thermal runaway, the thermal runaway suppression sheet of the disclosure placed between cells in a battery pack or module, or between the battery and the housing for enclosing the battery pack or module, can prevent and suppress a propagation of the thermal runaway to neighboring cells and battery.

### BRIEF DESCRIPTION OF THE DRAWINGS

FIG. 1 illustrates a structural schematic diagram of one embodiment of a battery pack or battery module using the thermal runaway suppression sheet.

FIG. 2 illustrates a structural schematic diagram of another embodiment of a battery pack or battery module using the thermal runaway suppression sheet.

FIG. 3 illustrates a schematic diagram showing the thermal runaway suppression sheet used in the battery or module depicted by FIG. 2.

FIG. 4 is a diagram for explaining the thermal insulation evaluation test 1 conducted in Examples.

FIG. 5 is a diagram for explaining the thermal insulation evaluation test 2 conducted in Examples.

FIG. 6 is a diagram for explaining a thermal diffusion evaluation test conducted in Examples.

FIG. 7 is a diagram for explaining the thermal insulation and heat shrinkability tests conducted in Examples.

FIG. 8 is a graph showing the results of a thermal insulation evaluation test with respect to a fabric-type thermal energy consumption layer with or without heat treatment.

FIG. 9 is a graph showing the results of an evaluation test investigating the thermal insulation performance of a combination of a thermal diffusion layer and a thermal energy consumption layer.

FIG. 10 is a graph showing the results of a thermal insulation evaluation test of a thermal runaway suppression sheet comprising a papermaking-type thermal energy consumption layer.

FIG. 11 is a graph showing the test results of the dependency of the thermal insulation performance on the mode of use of the thermal runaway suppression sheet.

FIG. 12 is an electron micrograph (1000× magnification) of the surface of a thermal runaway suppression sheet having a boron nitride-coated film.

FIG. 13 is a photograph of a papermaking-type silica-based fiber sheet which underwent a thermal diffusion evaluation test.

FIG. 14 is a photograph of the thermal runaway suppression sheet No. 4 which underwent a thermal diffusion evaluation test.

FIG. 15 is a photograph of the thermal runaway suppression sheet No. 2 which underwent a thermal diffusion evaluation test.

### EMBODIMENT FOR CARRYING OUT THE INVENTION

The thermal runaway suppression sheet of the invention is a layered sheet including a thermal energy consumption layer capable of consuming thermal energy through dehydration condensation and a thermal diffusion layer capable of diffusing a localized thermal energy, along the planar direction of the diffusion layer. Other layers such as adhesive layers, reflector layers, silica aerogel-containing layers, and so on, may be optionally included.

[Thermal energy consumption layer]A thermal energy consumption layer is a layer that can reduce an amount of thermal energy by consuming thermal energy by itself. Specifically, it is a sheet formed from a silica-based inorganic fiber containing hydroxyl groups or a clump of the silica-based inorganic fiber, which is, hereinafter, sometimes simply referred to as a “silica-based fiber sheet”.

The silica-based fiber sheet is a nonwoven fabric or paper formed from the inorganic fiber or a clump thereof, alternatively a sheet-like fabric obtained by weaving or knitting a yarn obtained by spinning or twisting the silica-based fiber or fibers. The nonwoven fabric or paper is usually obtained by wet papermaking, hereinafter, which is referred to as “papermaking-type thermal energy consumption layer” or “papermaking-type silica-based fiber sheet”. The sheet-like fabric is referred to as “fabric-type thermal energy consumption layer” or “silica-based fiber fabric”. Among these, the papermaking-type thermal energy consumption layer is preferable because the content of the silica-based inorganic fibers in the sheet can be adjusted while the sheet keeps the fibers homogeneously dispersed therein.

### (1) Silica-Based Inorganic Fiber

The silica-based inorganic fiber having a hydroxyl group has 81% by weight or more of SiO₂, and Si(OH) exists in a part of the SiO— network. A metal or metal oxide ion (such as Al³⁺, TiO²⁺ or Ti⁴⁺, and ZrO²⁺ or Zr⁴⁺) contained in a starting glass material may be substituted with a proton to become a hydroxyl group during the process of making a filament or staple fiber from the starting glass material. The hydroxyl group may be left in the silica-based inorganic fiber. The hydroxyl groups contained in the fiber undergo a condensation reaction at about 300 to 700° C. as shown in the following formula (1) to form a new siloxane bond (Si—O—Si bond) and H₂O can be released.

$$\begin{matrix}[ Formula 1 ] & \\ {Si ( OSi )}_{3} OH + HO \cdot Si \to {Si ( OSi )}_{4} + {H}_{2} O & ( 1 )\end{matrix}$$

The silica-based inorganic fiber may preferably have the following composition, but not limited thereto.

SiO₂: from 81 to 97% by weight;

Al₂O₃: from 3 to 19% by weight; and

2% by weight or less of one or more components selected from ZrO₂, TiO₂, Na₂O, Li₂O, K₂O, CaO, MgO, SrO, BaO, Y₂O₃, La₂O₃, and Fe₂O₃ (referred to as “other component”).

The silica-based inorganic fiber is obtainable by melting a starting glass material having the following composition:
from 55 to 80% by weight of SiO₂,
from 5 to 19% by weight of Al₂O₃,
from 15 to 26% by weight of Na₂O,
from 0 to 12% by weight of ZrO₂,
from 0 to 12% by weight of TiO₂, and
1.5% by weight or less of one or more components selected from Li₂O, K₂O, CaO, MgO, SrO, BaO, Y₂O₃, La₂O₃, and Fe₂O₃;
forming filaments or staple fibers from the melt;
acid extracting the resulting filament or staple fiber;
removing a residual acid and/or salt residues from the extracted filament or staple fiber, and thereafter drying the filament or staple fiber.

Alkali metal ions are replaced with protons in an acid treatment, but the alkali metal ions (A³⁺, TiO²⁺ or Ti⁴⁺, and ZrO²⁺ or Zr⁴⁺) may still remain in the SiO— network.

Metal ions substituted with protons in the silicon dioxide backbone may leave a certain number of hydroxyl groups, depending on the valence of the metal ion. These hydroxyl groups may be condensed at about 300 to 700° C. as shown in the above formula (1) to form a new Si—O—Si bond and release H₂O.

Water generated by dehydration condensation vaporizes in a high-temperature atmosphere. At this time, since the thermal energy given to the silica-based fiber sheet is consumed for vaporization, a temperature rise of the sheet can be suppressed. In this way, the thermal energy from the thermally runaway cell is consumed and a reduction in the temperature of the surface (back surface) opposite to the side in contact with the thermally runaway cell can be achieved.

The silica-based inorganic fiber forming the sheet is not particularly limited as long as it contains Si(OH) in the composition, but a typical example includes a composition represented by AlO_{1.5}·18[(SiO₂)_{0.6}(SiO_{1.5}OH)_{0.4}].

An inorganic fiber having such a composition may be a staple fiber having a diameter of 6 to 13 μm, preferably 7 to 10 μm, and a length of 1 to 50 mm, preferably 1 to 30 mm, or a filament having a diameter of about 6 to 13 μm, preferably about 7 to 10 μm, and a length of about 30 to 150 mm, which can be produced by melt spinning. Alternatively, a yarn obtained by spinning the staple fiber or twisting the filament may be applicable. Since the staple fiber and filament are produced by cutting the continuous material obtained by continuous spinning after melting, shot is not substantially contained in the silica-based inorganic fiber. Therefore, the silica-based inorganic fibers used in the invention, in any form of staple fibers, filaments, yarns, or its sheet-like clump, can comply with the safety standards of the Industrial Safety and Health Law Enforcement Ordinance, and are not banned under the regulation by the Ordinance on Prevention of Hazards from Specified Chemical Substances.

As such silica-based inorganic fibers, a commercially available one such as BELCOTEX (registered trademark) from BELCHEM GmbH can be used. BELCOTEX (registered trademark) is a fiber generally made from silicic acid modified with alumina, and contains about 94.5 wt % of silica, about 4.5 wt % of alumina, less than 0.5 wt % of oxides, and less than 0.5 wt % of other components. It has a melting point of 1500° C. to 1550° C. and heat resistance up to 1100° C.

A silica-based fiber sheet that serves as a thermal energy consumption layer are typically classified into (A) nonwoven fabric or paper (papermaking-type thermal energy consumption layer (A)) and (B) fabric (fabric-type thermal energy consumption layer (B)). The nonwoven fabric or paper as the papermaking-type thermal energy consumption layer (A) is made by wet papermaking of staple fiber(s) of silica-based inorganic fiber. The fabric as the fabric-type thermal energy consumption layer (B) is a sheet by weaving or knitting silica-based inorganic fiber yarns or filaments.

### (A) Papermaking-Type Thermal Energy Consumption Layer

The papermaking-type thermal energy consumption layer is made by dispersing a composition for the energy consumption layer in water, the composition comprising silica-based inorganic fiber, optionally other inorganic fibers, organic binder, and an additive to make a uniform slurry, papermaking the slurry with a paper machine, removing extra water by press, followed by drying to form a sheet.

### <Composition of Slurry>

A typical composition of the slurry comprises from 50 to 80% by weight of the silica-based inorganic fiber, from 2 to 20% by weight of the glass fiber, and from 3 to 15% by weight of the organic fiber, and optionally from 10 to 40% by weight of the fibrous mineral, in terms of the solid content in the slurry (suspension).

(a1) Silica-based inorganic fiber

A staple fiber of the aforementioned silica-based inorganic fiber is used for the silica-based inorganic fiber. Therefore, the silica-based inorganic fiber may be a staple fiber having a diameter of 6 to 13 μm, preferably 7 to 10 μm, and a length of 1 to 50 mm, preferably 3 to 30 mm.

The silica-based inorganic fiber as described above is contained in a solid content of 50 to 80% by weight, preferably 55 to 75% by weight in the slurry. Therefore, the content in the sheet is around the range between 50 and 80% by weight, preferably around between 55 and 75% by weight. Further, the content of silica-based inorganic fibers in the sheet is from 100 kg/m³ to 400 kg/m³.

As already described, a silica-based inorganic fiber having a hydroxyl group can consume thermal energy through a dehydration condensation reaction under a condition of high temperatures. The composition may suppress a temperature rise at an initial stage of thermal runaway. Therefore, if the content of the silica-based inorganic fiber is too low, the consumption of the thermal energy by the silica-based fiber contained in the sheet may be small, and the temperature rise at the initial stage may not be sufficiently suppressed. On the other hand, dehydration condensation reaction causes a shrinkage of the silica-based inorganic fiber. If the shrinkage becomes large due to unduly high content of the silica-based fiber, the thermal runaway suppression sheet might develop a crack due to a serious difference in heat shrinkage of layers in the laminated structure.

### (a2) Glass Fiber

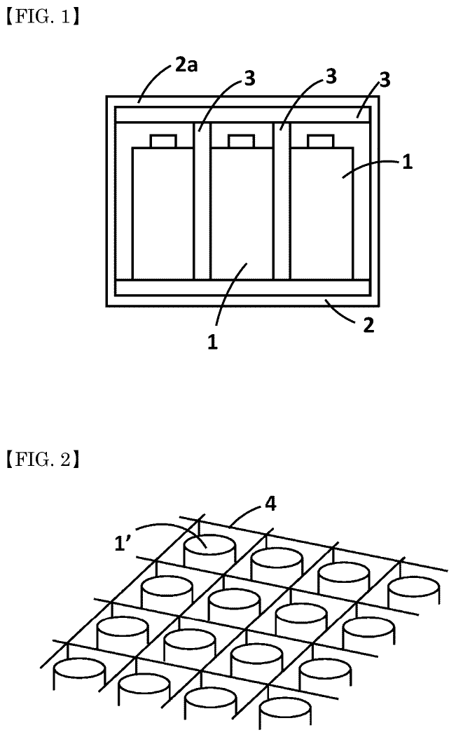

The papermaking-type thermal energy consumption layer contains from 2 to 20% by weight of glass fiber. A glass fiber softens and/or melts at a high temperature, especially at a temperature as high as an exposure to flame. Under such a high temperature, the glass fiber cannot retain its fibrous form. The silica-based fiber may shrink due to dehydration condensation at a temperature such that the glass fiber begins to soften and melt, while the molten glass fiber may flow into a gap between the silica fibers. When the content of glass fiber is within the above-mentioned range, the molten glass fiber may spread like a film between the silica fibers to offset the shrinkage of the silica-based fibers. Such offset may occur in the thermal runaway suppression sheet to be attached to the lid. In an exemplary case shown in FIG. 1, the molten glass fiber in the thermal runaway suppression sheet to be attached to the lid may be avoided from dripping due to its own weight. In other words, the glass fiber may make a role of securing the sheet form of the thermal runaway suppression sheet under the condition of high temperatures.

Taking account of the role of the glass fiber, the glass fiber does not need to heat resistance such that its fibrous form can be retained even when exposed to flame. Therefore, a glass fiber made of soda glass, C glass, or E glass, which has a relatively low melting point and/or softening point, may be used from the standpoint of availability and cost. The type and size of the glass fiber are not particularly specified.

The fiber diameter is from about 1 to 10 μm, preferably about 2 to 9 μm, more preferably about 3 to 8 μm. The glass fiber should have a length and durability sufficient enough to be entangled with the silica-based fiber and the organic fiber described later. Since a glass fiber is molten at a temperature (about 700° C.) as high as a temperature when exposed to flame, the molten glass fiber changes into a large glass drop and the glass drop will sag due to its own weight. Therefore, the glass fiber used may be preferably a staple fiber having a fiber length of 1 to 15 mm, preferably 2 to 10 mm.

### (a3) Organic Fiber

An organic fiber can function as an organic binder in the papermaking process.

An appropriate organic fiber used in the invention may be a fiber having a softening temperature of about 100 to 240° C. or a melting temperature of about 125 to 260° C., or having a heat resistance temperature higher than such a softening or melting temperature.

Examples of the organic fiber include pulp fiber, polyester fiber, polypropylene fiber, polyethylene fiber, acrylic fiber, polyvinyl chloride fiber, vinylidene fiber, nylon fiber, vinylon fiber, polyvinyl alcohol fiber and the like. A thermoplastic resin fiber having a core-sheath structure in which the core fiber is covered with a resin having a lower softening temperature may also be used.

In the case of using the organic fiber as the organic binder, the organic fiber can be entangled with the silica-based fiber and the glass fiber in the papermaking process.

The silica-based fiber and the glass fiber have a high elastic modulus, however, these fibers may be bound by the entanglement of the organic fiber.

In particular, the organic fiber may be softened and molten due to heat in the drying process as a post-papermaking process, and act as a binder for the glass fiber and the silica-based fiber.

In addition, the organic fiber may reinforce the wet web during papermaking.

Moreover, after papermaking process, the softened organic fiber may facilitate a paper processing for forming a desired shape, such as providing a slit or folding, which is advantageous for shaping and/or processing.

A staple fiber having a diameter of 3 μm to 50 μm, preferably 5 μm to 30 μm, and a length of 1 to 20 mm, preferably 3 to 10 mm is preferably used as the organic fiber workable as the organic binder. A preferable organic fiber has a length sufficient to uniformly entangle with an inorganic fiber which is a main component of the sheet.

The above-mentioned organic fibers may be contained in an amount necessary and sufficient for assuring to follow up the post-processing and thermal processing of the shaped sheet, or to mitigate expansion and contraction of the sheet due to a variation in temperature in a normal use. Unduly high content of the organic fiber may decrease heat resistance of the sheet. In addition, an organic component may be oxidized to generate a thermal energy or generate a decomposed gas due to the exposure to a battery cell having an elevated temperature.

However, in the case that the organic fiber content is chosen to a relatively small amount of 15% by weight or less, preferably 10% by weight or less, and more preferably 8% by weight or less, the organic fiber could be combusted and vaporized (burnout) during an initial period of thermal runaway. Therefore, the organic fiber might not affect a heat resistance of the thermal runaway suppression sheet.

(a4) fibrous mineral

The thermal energy consumption layer in a papermaking-type sheet may further contain a fibrous mineral. The fibrous mineral used in the invention is mineral powder consisting of fibrous, dendritic, acicular, columnar, or rod-like particle. The shape of the particle can be recognized by microscopic observation. Therefore, the fibrous mineral may sometimes be referred to as a mineral fiber.

The aspect ratio of the fibrous mineral, length/width, is 10 or more, preferably 15 or more, and 200 or less, preferably 150 or less, wherein the length and width correspond to length and diameter of the fiber respectively.

The fibrous mineral has an average primary particle size of 10 μm to 100 μm, preferably 15 μm to 70 μm. In the case of a curved or crimped fibrous mineral, a circular shape is hypothetically made based on the terminal length of the two-dimensionally projection of the curved or crimped fiber, the diameter of the circular shape may be employed as an average particle size. A desirable fibrous mineral may be obtained by classifying based on a maximum particle size using a sieve.

As the fibrous mineral, it is preferable to use at least one selected from the group comprising sepiolite, palygorskite, potassium titanate whisker, and wollastonite.

Sepiolite and palygorskite are layered silicates classified as a clay mineral having a fibrous morphology. The width corresponding to the fiber diameter is less than 0.1 μm, and the length (fiber length) measurable by microscopic observation is about 150 μm at most.

Sepiolite is a hydrous magnesium silicate with a ribbon structure having a ratio of 2:1. Sepiolite is classified into α-type and β-type based on the difference in origin, and both types may be used, but the α-type is preferably used. The α-type sepiolite is longer and has a higher degree of crystallinity, due to exposure to hydrothermal action under the condition of high temperature and pressure. The β-type sepiolite is a short fiber like a massive or clay-like form, and has a relatively low degree of crystallinity due to its origin of sedimentation at the bottom of shallow sea or lake.

The layered structure of sepiolite has a chain structure. Also, the sepiolite is porous and has a large specific surface area, and therefore has excellent adsorption property. Sepiolite having such properties may exhibit thixotropic property and may be pulverized into fibrous form in a slurry using water as a dispersing medium. In addition, since sepiolite is so plastic and flexible to intrude into a gap between fibers, the sepiolite can function as a binder between fibers after being dried and consolidated.

Wollastonite is metasilicate and an acicular crystal mineral with a length of about 50 μm and a width (fiber diameter) of 1 μm or less.

Potassium titanate is an acicular single crystal (whisker). A typical whisker has a fiber diameter of 0.1 to 0.5 μm and a length of 10 to 50 μm. A commonly available whisker has a length of 15 to 30 μm.

The content of the above-mentioned fibrous mineral contained in the silica fiber sheet is preferably 40% by weight or less, more preferably 10 to 35% by weight.

Such fibrous mineral particle can be entangled with silica-based fiber, glass fiber, and organic fiber in the slurry. In this regard, other mineral particle, such as plate-like clay minerals such as mica and talc, hardly entangle with a fiber in a slurry. For this reason, the other mineral is easy to fall off from a dry sheet. On the other hand, a fibrous mineral can be entangled with silica-based fiber, glass fiber, and organic fiber during the slurry preparation process, so even in the sheet produced by papermaking, the fibrous mineral is stably held and is less likely to fall off. Moreover, the fibrous mineral may contribute to reinforcing the sheet.

In particular, the fibrous mineral may enhance a tensile strength of a silica-based fiber sheet under the condition of a high temperature, based on its high heat resistance. This is beneficial because a glass fiber contained in the sheet cannot contribute to the tensile strength of the sheet under the condition of a high temperature.

On the other hand, the fibrous mineral is usually inferior to the silica-based fiber in thermal insulation performance, especially under the condition of a high temperature. An increased content of the fibrous mineral leads to decrease the content of the silica-based fiber, which means that the temperature rise suppression effect of the silica-based fiber by the dehydration condensation is reduced. Therefore, the content of the fibrous mineral is 40% by weight or less, preferably 10 to 35% by weight.

### (a5) Other Fillers

In addition to the above-mentioned solid components, another solid filler may be contained in the slurry, in an amount of less than 10% by weight, preferably less than 5% by weight, more preferably 3% by weight or less.

The other filler may include a clay mineral (layered silicate) other than the said fibrous mineral. For example, a hydrous ferrosilicate mineral such as mica, kaolinite, smectite, montmorillonite, sericite, illite, glauconite, chlorite, and talc, or a mixture thereof may be contained. Among these, smectite, montmorillonite, bentonite, and a mixture thereof are preferably used.

An organic binder having any form other than fiber, such as powder, granule, colloidal solution, and high-viscosity fluid, may be used. The organic binder with any form may soften and deform to be embedded in the gap between inorganic particles held by the inorganic fibers in a normal use as well as rise in temperature until the glass fiber is molten. This may allow the inorganic particles kept in a stable state. Moreover, a thermal runaway suppression sheet placed between battery cells enables to mitigate size fluctuations of the thermal runaway suppression sheet in a normal use. Even in a normal use, the size fluctuation of the thermal runaway suppression sheet may occur by expansion or compression of the battery cells.

Examples of the organic binder other than fibrous binder include powder or fluid of polymer. For example, latex such as acrylic latex and (meth)acrylic latex; powdery thickening substance such as polyvinyl alcohol powder and starch; a copolymer of styrene and butadiene, vinylpyridine, acrylonitrile, and a copolymer of acrylonitrile and styrene, may be used.

If needed, in addition to the fillers mentioned above, dispersants, paper strength agents, thickeners, inorganic fillers, organic fillers, antifoaming agents and the like may be optionally contained.

### (a6) Dispersion Medium

Any dispersion medium used for a slurry for papermaking may be applicable as long as the silica-based fiber, glass fiber, fibrous mineral, and thermoplastic resin fiber may be uniformly dissolved or dispersed in the medium.

Examples of the dispersion medium include aromatic hydrocarbons such as toluene, ethers such as tetrahydrofuran, ketones such as methyl ethyl ketone, alcohols such as isopropyl alcohol, N-methyl-2-pyrrolidone (NMP), dimethylacetamide, dimethylformamide, dimethylsulfoxide, water or the like. The dispersion medium may be appropriately chosen from those, and water is preferable.

### <Preparation of Slurry Used for Papermaking>

Each of the components listed above, namely silica-based fiber, glass fiber, and organic binder, and an optional component such as a fibrous mineral and other filler, are added to the dispersion medium in a predetermined amount, stirred, and thus a slurry for papermaking, which is a suspension containing the components for the sheet, is obtained.

The solid content in the slurry may be set so as to obtain a slurry in which components are homogenously mixed. Specifically, the solid content is from 0.01 to 10% by weight, preferably 0.05 to 3% by weight.

The order of the components in the blending process is not particularly specified. The fibers and other fillers are preferably added to the dispersion medium with stirring the suspension.

### <Wet Papermaking>

Wet papermaking is a manufacturing process of sheet or paper. In the process, the slurry prepared above is drained through sieve-like screen, pressed, and then dried with a paper machine.

As the paper machine, a cylinder paper machine, a fourdrinier paper machine, an inclined paper machine, an inclined short wire machine, and a combination of these may be used.

In the drying process, the dispersion medium is removed from the pressed sheet. The drying temperature is lower than a melting point of the organic fibers and higher than the boiling point of the dispersion medium. The drying temperature is usually chosen between 80° C. and 200° C., preferably between 100° C. and 150° C., depending on the composition of the slurry.

A producing method of paper in which the fibrous material is embedded is not limited to a papermaking from a slurry containing the fibrous mineral. The paper may be prepared by post-addition or external addition of the fibrous mineral to a sheet produced from a slurry not containing a fibrous mineral. The post-adding method may be conducted by spray-coating, curtain coating, impregnation coating, bar coating, roll coating, or blade coating, a slurry containing the fibrous mineral over the sheet not containing a fibrous mineral. In the case of the paper produced by the post-addition or external addition of the fibrous mineral and/or inorganic particle, the fibrous mineral and/or inorganic particle tend to be held on a surface of the sheet. Since the dried fibrous mineral as well as inorganic particle are powdery, they are likely to scatter. In this regard, in the thermal runaway suppression sheet manufactured by collecting and screening the fibrous mineral along with the inorganic fibers as the main component of the sheet, the fibrous mineral may be interwoven with the inorganic fibers and may be held by the entangled fibers. Thereby the dried fibrous mineral may still stay in the sheet.

### (B) Fabric-Type Thermal Energy Consumption Layer

The fabric-type thermal energy consumption layer is composed of a sheet-shaped fabric obtained by weaving or knitting yarn or filament of the silica-based inorganic fiber.

The yarn or filament used for weaving or knitting may be a filament have a diameter of about 6 to 13 μm, preferably about 7 to 10 μm, and a length of about 30 to 150 mm, the filament directly produced by melt spinning. A thread (yarn) obtained by spinning and twisting a staple fiber having a length of 30 mm or less may also be used.

Regarding a woven fabric, plain weave, twill weave, satin weave, and the like may be applicable for the weaving method of the woven fabric, but not limited thereto. Plain weave is preferable because the thermal energy consumption layer consisting of the plain weave fabric can contact with the thermal diffusion layer in a broader area.

In the case of knitted fabric, the knitting method is not particularly limited, and warp knitting, weft knitting, flat knitting, rubber knitting, pearl knitting and the like may be applicable for the knitting method.

### <Silica Fiber Sheet>

A thermal energy consumption layer has a thickness of 0.4 to 2.0 mm, preferably 0.5 to 1.8 mm, more preferably 0.6 to 1.6 mm, independent of (A) papermaking-type or (B) fabric-type silica-based fiber sheet. Unduly thin silica-based fiber sheet does not have such a sufficient silica-based fiber to exert a desirous thermal energy attenuation, and as a result, the effect of delaying thermal runaway would not be exhibited. On the other hand, the thickness of the entire thermal runaway suppression sheet should be 3.0 mm or less, preferably 2.5 mm or less, and more preferably 2.0 mm or less because the thermal runaway suppression sheet is placed between cells. A sheet having a thickness of 1.8 mm or less is preferable in view of a limited space between cells.

The fiber content in the silica-based fiber sheet is in the range of 100 kg/m³ to 400 kg/m³, preferably 120 kg/m³ to 400 kg/m³, more preferably 140 kg/m³ to 250 kg/m³, in the case of the (A) papermaking-type thermal energy consumption layer. This range of density is required in order to obtain a thermal insulation effect based on the thermal energy consumption layer. On the contrary, if the papermaking-type thermal energy consumption layer has unduly high density, which means the thermal energy consumption layer having unduly low porosity, a significantly lowered void filled with air would not provide a desired thermal insulating performance.

In the case of the (B) fabric-type thermal energy consumption layer, the fiber content ratio in the sheet, i.e. density of the layer, is usually from 400 kg/m³ to 1500 kg/m³, preferably 700 kg/m³ to 1300 kg/m³, depending on the yarn used and basis weight in the woven fabric. The density of the (B) fabric-type thermal energy consumption layer tends to be higher than the (A) papermaking-type thermal energy consumption layer.

### [Thermal Diffusion Layer]

The thermal diffusion layer is a layer having a thermal conductivity in the planar direction of 10 to 200 times, usually 20 to 100 times, as large as the thermal conductivity in the thickness direction. The thermal diffusion layer is capable of diffusing thermal energy along its planar direction. Based on this property, when a thermal runaway suppression sheet is locally exposed to a high temperature by a thermally runaway trigger cell, the thermal energy can be spread throughout the sheet mainly in the planar direction rather than in the thickness direction.

The thermal diffusion layer is a layer made of graphite or boron nitride. These have a thermal conductivity in the planar direction by 10 to 200 times larger than that in the thickness direction. Graphite and boron nitride have a layered structure in crystal form and have a cleavage property which allows layers to be separated easily because of weak bonding via van der Waals force.

The thermal diffusion layer made of graphite, boron nitride, or the like may be a sheet or a coating layer over the thermal energy consumption layer. The coating layer may be formed either by a dry process such as vapor deposition or sputtering, or by coating the surface of the thermal energy consumption layer with a liquid containing graphite, boron nitride, or the like.

### (1) Sheet-Type Thermal Diffusion Layer

The sheet-type thermal diffusion layer is a sheet containing a substance capable of diffusing thermal energy such as graphite, boron nitride, and so on, as a main component. The content of the substance in the sheet-type thermal diffusion layer is from 80 to 100% by weight, preferably 90 to 100% by weight. As a typical sheet-type thermal diffusion layer, an expanded graphite sheet and a boron nitride sheet are described below.

### (1-1) Expanded Graphite Sheet (GS)

Any expanded graphite sheet obtainable by rolling and molding expanded graphite into a sheet shape may be used. Alternatively, a polymer-type expanded graphite sheet obtainable by heating a polymer film such as an aromatic polyimide sheet up to over 2500° C. in a reducing atmosphere and under pressure to graphitize may also be used.

Expanded graphite can be produced, for example, by treating graphite powder such as natural flake graphite, pyrolytic graphite, Kish graphite, with an inorganic acid such as sulfuric acid or nitric acid and a strong oxidizing agent such as concentrated nitric acid, perchloric acid, bichromate, and hydrogen peroxide to generate a graphite intercalation compound, followed by washing with water, drying, and rapidly heating to 1000° C. or higher. As a result, the intercalation compound is gasified, and the graphite layers are pushed up to expand up to several hundred times of its starting volume.

The expanded graphite sheet usually has a thickness of about 10 μm to 2 mm, depending on the manufacturing method. In the thermal runaway suppression sheet of the present invention, an expanded graphite sheet having a thickness of 1 mm or less, more preferably 0.5 mm or less, and still more preferably about 50 μm to 400 μm (0.4 mm) may be allowed for satisfying the requirement for the entire thickness of the thermal runaway suppression sheet.

The expanded graphite sheet has a bulk density of 0.5 to 1.6 g/cm³, preferably 0.5 to 1.1 g/cm³. The thermal conductivity, which is an important property of the thermal diffusion layer, varies in proportion to the bulk density of the sheet material. When the bulk density of the expanded graphite sheet is too low, it becomes difficult to obtain the effect expected as a thermal diffusion layer, and the oxidation resistance tends to be lowered. On the other hand, if it is too high, the thermal insulating effect based on filled air in pores tends to be decreased due to lowered porosity.

The expanded graphite sheet has a thermal conductivity in the planar direction of 50 to 500 W/mK, preferably 100 to 300 W/mK, and a thermal conductivity in the thickness direction is from 2 to 10 W/mK, preferably 3 to 8 W/mK, depending on the type of graphite, impregnated acid, graphite content, and the like.

The expanded graphite sheet is oxidatively consumed when exposed to high temperatures for a long time, but can resist to be heated and oxidized in the case of the exposure to a high temperature around 1000° C. for about 1 hour.

### (1-2) Boron Nitride Sheet

The boron nitride sheet can be produced, for example, by subjecting boron nitride powder to wet papermaking together with a binder fiber. The binder fiber may be a thermoplastic fiber such as polyester fiber, polyamide fiber, pulp fibers, and the like. After wet papermaking, the paper may be densified and thinned by hot pressing.

Depending on the particle size and content of the boron nitride used, the thermal conductivity in the planar direction is from about 8 to 40 W/m·K, and the thermal conductivity in the thickness direction is from about 0.3 to 4 W/m·K.

Boron nitride is excellent in electrical insulation, and therefore, is preferably applicable in use where electrical conductivity in the planar direction of the sheet is focused.

In addition, the expanded graphite sheet may be lower than the silica-based fiber sheet in voltage resistance. In the case that a voltage resistance is required, the surface (not in contact with the silica-based fiber sheet) of the expanded graphite sheet may be coated with or covered with an insulating layer such as silica-based fiber sheet or silica aerogel-containing layer.

### (2) Coat-Type Thermal Diffusion Layer

The coat-type thermal diffusion layer is formed by coating the surface of the silica-based fiber sheet as a thermal energy consumption layer, with a dispersion liquid containing a thermal diffusing substance such as graphite or boron nitride powder, in a dispersion medium such as water.

The dispersion liquid may further contain a surfactant, an organic binder, and the like in a solid content of 15% by weight or less, preferably 10% by weight or less.

Non-limiting method of applying the dispersion liquid includes a coating method, a spraying method, and the like.

Subsequently to the application of the dispersion liquid, it is dried to form a graphite or boron nitride film on the surface of the silica-based fiber sheet. In the case of a papermaking-type silica-based fiber sheet, a coating layer containing graphite or boron nitride may be formed in the inter-fiber gaps.

A laminated unit corresponding to a combination of a thermal diffusion layer and a thermal energy consumption layer (silica-based fiber sheet) is called as “thermal diffusion layer/thermal energy consumption layer”. If a cell undergoes thermal runaway, a layer of the laminated unit in contact to the cell is locally heated due to the thermal runaway. In this case, the thermal energy consumption layer in the laminated unit may attenuate and consume thermal energy through vaporization of water generated by the condensation reaction of silica-based inorganic fibers contained in the thermal energy consumption layer. Furthermore, the thermal diffusion layer in the laminated unit may spread the thermal energy to the entire surface, thereby distributing the thermal energy to the whole thermal energy consumption layer and promoting the condensation reaction of silica-based fibers throughout the sheet. As a result, the thermal energy can be consumed by the whole thermal energy consumption layer, so that an excellent temperature reduction effect can be obtained.

Such a temperature reduction effect can be obtained in either case of contacting the heat source with the thermal energy consumption layer or the expanded graphite sheet as a thermal diffusion layer.

### [Other Layers]

The thermal runaway suppression sheet of the invention may contain another layer such as an adhesive layer, in addition to the thermal energy consumption layer and the thermal diffusion layer.

### (1) Adhesive Layer

In the case that the thermal diffusion layer is an individual sheet like an expanded graphite sheet, an adhesive layer may be interposed between the thermal energy consumption layer and the sheet-type thermal diffusion layer, according to needs.

A pressure-sensitive adhesive such as an elastomer-based adhesive is preferably used for an adhesive in the adhesive layer, from the viewpoint of not impairing the flexibility and softness of the thermal runaway suppression sheet.

Non-limiting examples of the elastomer as a main component of the pressure-sensitive adhesive include rubber-based, acrylic-based, or silicone-based elastomer. A solvent type, emulsion type, hot melt type, aqueous solution type and the like type adhesive may be used, but an emulsion type adhesive and a solvent type adhesive are preferred because of the workability in the processes of laminating the thermal energy consumption layer and the thermal diffusion layer, and coating the adhesive.

### (2) Reflector Layer

A reflector layer is a layer having a role as a reflector of radiant heat energy.

The reflector layer may be laminated on the thermal energy consumption layer or the thermal diffusion layer, or may be interposed between the thermal energy consumption layer and the thermal diffusion layer. Preferably, it is interposed between the thermal energy consumption layer and the thermal diffusion layer. When either a thermal energy consumption layer or a thermal diffusion layer faces a trigger cell in which thermal runaway occurs, the reflector layer would reflect thermal energy released from the trigger cell, and thereby decreasing the thermal conduction to the opposite side of the sheet. This may expect to enhance the thermal insulating performance of the thermal runaway suppression sheet.

Such a reflector layer may be composed of a metal foil or a metal deposition layer.

The metal used for metal foil or metal vapor deposition includes highly reflective metals such as aluminum, stainless steel, titanium, chromium, nickel and gold, preferably aluminum.

The reflector layer has a thickness of usually 5 to 25 μm, preferably 10 to 18 μm. This range of thickness may function expectedly as a reflector layer. Unduly thick thermal runaway suppression sheet is rigid, and is short of flexibility, resulting in difficulty in handleability of the sheet.

### (3) Aerogel-Containing Layer

The silica aerogel-containing layer is a layer in which silica aerogel is held by entangled fibers. The silica aerogel has a high porosity and thereby providing a silica aerogel-containing layer with an excellent thermal insulation performance.

The silica aerogel may be supported by a lump of fibers in a shape of sheet. Examples of the fiber include glass fiber; ceramic fiber such as silica fiber, alumina fiber, titania fiber, and silicon carbide fiber; metal fiber; artificial mineral fiber such as rock wool and basalt fiber; carbon fiber, whisker, and so on. The lump of fibers may be made into a paper or board by a papermaking method, or may be formed into a sheet-shaped molded product with an appropriate binder.

The content ratio in weight of the lump of fibers as a sheet-shaped carrier to the silica aerogel is from preferably 9:1 to 5:5, more preferably 8:2 to 6:4.

### [Thermal Runaway Suppression Sheet]

Embodiments of the thermal runaway suppression sheet of the invention include a thermal energy consumption layer alone; a laminate comprising a thermal energy consumption layer and a thermal diffusion layer; and a laminate further comprising an adhesive layer interposed between the thermal energy consumption layer and a thermal diffusion layer. A multi-layered sheet optionally comprising an aerogel-containing layer and a reflector layer in addition to the thermal energy consumption layer, thermal diffusion layer, and the adhesive layer, is also included in the invention.

Even if an adhesive layer is not interposed, the thermal energy consumption layer and the thermal diffusion layer can be joined together, for example, by hot pressing in a laminated state.

In the case of a layered structure including an aerogel-containing layer and a reflector layer, the layer arrangement or layer configuration of these layers to the thermal energy consumption layer or the thermal diffusion layer is not particularly limited.

If a layer, aside from the thermal energy consumption layer and the thermal diffusion layer, is added, the selection of the additional layer and its arrangement in the layered structure is based on factors such as the nature of the additional layer, its interaction with the overall thickness of the thermal runaway suppression sheet, the intended usage condition, and so on. However, regarding the additional layers in the thermal runaway suppression sheet, very few and relatively thin layers are preferred to exert a sufficient energy consumption effect through the silica-based inorganic fiber.

The thermal runaway suppressing sheet having the above-mentioned structure is used in a battery pack or battery module. For instance, as shown in FIG. 1, a plurality of battery cells 1 are arranged in a housing 2, and the thermal runaway suppression sheet is placed between the battery cells 1. The battery cells 1 may be electrically connected either in series or in parallel in the battery module.

When one cell of the battery cells in the battery module triggers a thermal runaway, the thermal runaway suppression sheet 3 in contact with the trigger cell consumes thermal energy, and the initial temperature rise can be delayed. Thermal energy is spread along the plane of the thermal diffusion layer, and thereby suppressing localized and excessive heat on the sheet, and suppressing the thermal runaway of an adjacent cell. Therefore, the thermal runaway caused from a trigger cell can be suppressed to propagate to its adjacent cells.

The thermal runaway suppression sheet of the invention is not limited to be placed between battery cells. In a battery module shown in FIG. 1, the thermal runaway suppression sheet may be placed between the housing 2 and the battery cells 1 or may be attached to the rear surface of the lid 2a of the housing 2.

The thermal runaway suppression sheet 3 attached to the rear surface of the lid 2a can suppress the propagation of thermal runaway including heating an adjacent battery module, in the event that a thermal runaway trigger battery cell ignites or the electrolyte in the trigger battery cell spouts out.

The lid of the housing is commonly made of a thin plate of metal such as steel, aluminum, or an alloy thereof. In the case of applications where the thermal runaway suppression sheet is attached to the lid of the housing, the metallic plate of the lid may have a similar function of a thermal diffusion layer. Therefore, in this application, the thermal energy consumption layer can be used alone as a thermal runaway suppression sheet.

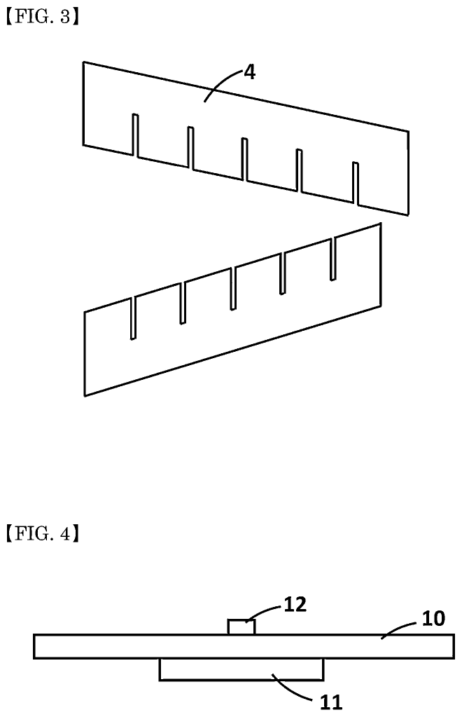

Further, as shown in FIG. 2, a separation sheet (separator) 4 may be placed between adjacent battery cells 1′ in a battery pack (module) in which cylindrical battery cells 1′ are arranged. For example, a slit-processed sheet as shown in FIG. 3 may be used for the separation sheet 4. Since the thermal runaway suppression sheet of the invention is flexible, durable and readily processed, the thermal runaway suppression sheet may be processed and used as the separator 4 in the battery pack (module).

A papermaking-type silica-based fiber sheet may be shaped into a desired shape in any step such as after papermaking, before drying, during drying, or after drying. For example, a desired shape may be given by press-molding under heating. A targeted shape with a slit or a bend may be given in a solidifying process of the sheet with an intended shape because pre-dried sheet has plasticity. In addition, a post-dried molded article may be further subjected to secondary processing such as cutting, punching, and bending.

In the case of a fabric-type thermal energy consumption layer, a secondary processing such as cutting, punching, and bending may be conducted in the state of silica fiber cloth or in a state of a laminate in which a thermal diffusion layer is laminated.

Either of a papermaking-type or a fabric-type thermal energy consumption layer may be processed or given an intended shape without being damaged, although the thickness of the thermal energy consumption layer is as thin as 0.1 to 2.0 mm. This may be contribution of the enhanced strength by the entanglement of fibers and a fibrous mineral.

### EXAMPLES

### [Measurement and Evaluation Method]

### (1) Measurement Method 1 for Thermal Insulation Performance:

As shown in FIG. 4, a sheet (150 mm×150 mm) 10 to be evaluated was placed on the upper surface of an electric heating furnace (100 mm×100 mm stainless steel plate) 11, and a thermocouple 12 was placed on back side of the sheet 10, the back side being opposite to the surface heated by the electric furnace 11 having a temperature of 700° C. The change in temperature was monitored during heating at 700° C. by the electric furnace 11.

### (2) Measurement Method 2 for Thermal Insulation Performance:

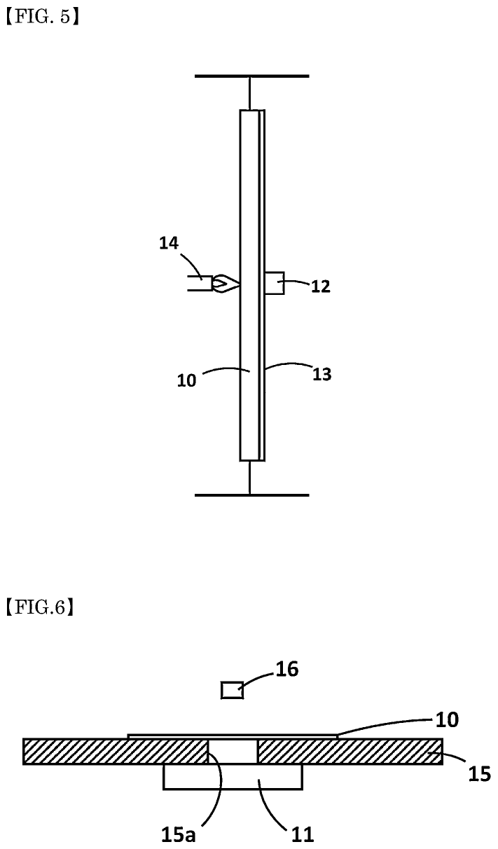

As shown in FIG. 5, the sheet (150 mm×150 mm) 10 to be evaluated was fixed vertically, one side was heated by the flame of the burner 14 fixed horizontally, and an iron plate 13 was placed on the sheet 10 at its back side which was not in contact with the flame. The change in surface temperature of the iron plate 13 was monitored by the thermocouple 12.

### (3) Thermal Diffusion

As shown in FIG. 6, a ceramic thermal insulating board (300 mm×300 mm, and 15 mm in thickness) 15 having a circular opening 15a with a diameter of 40 mm was placed on a hot plate (100 mm×100 mm) 11 heated at 700° C. Then, a sheet (150 mm×150 mm) 10 to be evaluated was placed so that the center of the sheet was positioned at the center of the circular opening 15a. In this state, the temperature of the entire surface of the sheet 10 was measured by the thermography 16, and the difference between the highest and the lowest in temperature of the surface of the sheet 10 was monitored for 5 minutes.

### (4) Thermal Insulation and Heat Shrinkage

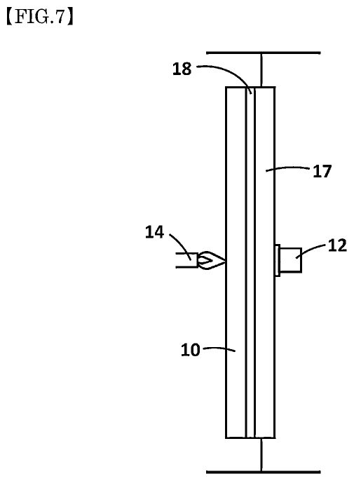

As shown in FIG. 7, a sheet (150 mm×150 mm) 10 to be evaluated was fixed to a cationic steel plate 17 (regarded as the lid of the housing) using an adhesive tape 18. The sheet 10 was heated by the flame of a horizontally fixed burner 14. The flame of the burner was positioned so that the temperature at a position of 5 mm apart from the surface of the sheet 10 heated by the flame was 1000° C. The temperature of the steel plate 17 was measured at a portion heated by the flame.

After heating for 10 minutes with the burner 14, the state of the sheet 10 (whether or not there are cracks, etc.) was observed. Moreover, the condition of the heated surface of the sheet after the flame exposure test was observed with a microscope.

### [Effect of Thermal Energy Consumption Layer]

### 1. Types of Thermal Energy Consumption Layers

### (A1) Fabric-Type Thermal Energy Consumption Layer

A plain weave fabric (thickness of 1.8 mm, bulk density of 444 kg/m³) using a pre-yarn (550 tex; spun yarn of staple fiber with a diameter of 9 μm and a length of 3 to 5 mm) of unheated BELCOTEX (registered trademark) 110 from BELCHEM GmbH was used. The BELCOTEX has the composition: AlO_{1.5}·18[(SiO₂)_{0.6}(SiO_{1.5}OH)_{0.4}].

### (B1) Papermaking-Type Thermal Energy Consumption Layer

A papermaking-type silica-based fiber sheet (thickness of 1.4 mm, 1.6 mm, or 1.8 mm, density of 200 kg/m³) obtained by wet papermaking with chopped strands (fiber diameter of 9 μm, fiber length of 3 to 5 mm) of unheated BELCOTEX (registered trademark) 110 from BELCHEM GmbH was used. The BELCOTEX has the composition:

AlO_{1.5}·18[(SiO₂)_{0.6}(SiO_{1.5}OH)_{0.4}].

### (C1) Comparative Example (Heat-Treated Silica-Based Fiber Sheet)

A fabric-type thermal energy consumption layer (A1) was heated at 700° C. for 8 hours and used as a comparative example.

### 2. Evaluation

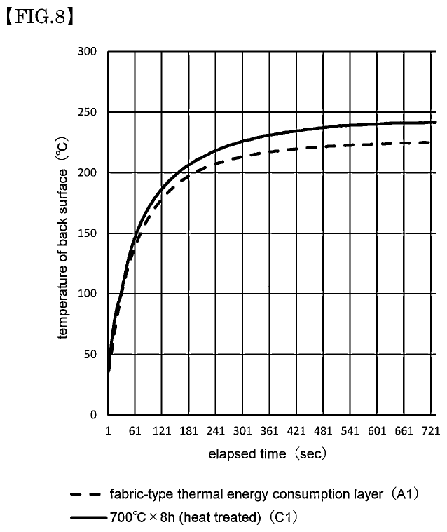

Above-mentioned sheets (150 mm×150 mm), i.e. the fabric-type thermal energy consumption layer (A1) and the heat-treated silica-based fiber sheet (C1) were evaluated with respect to the heat transfer suppression effect according to the measurement method 1. FIG. 8 shows the measurement result which is the temperature change for 11 minutes (700 seconds) from immediately (1 second) after being placed on the upper surface of the electric furnace.

In FIG. 8, the horizontal axis represents elapsed time, and the vertical axis represents temperature. The thermal energy consumption layer (A1) corresponding to a silica fiber sheet without the heat treatment is indicated by a dashed line, and the silica-based fiber sheet (C1) corresponding to heat-treated thermal energy consumption layer is indicated by a solid line.

As can be seen from FIG. 8, the thermal energy consumption layer (A1) had lower temperatures on the back surface (surface opposite to the electric furnace) than the silica-based fiber sheet (C1). Therefore, the former had a high thermal insulating performance. It is understood that, by heating with an electric furnace, a condensation reaction between terminal hydroxyl groups occurred in the silica-based fiber and generated water through the condensation reaction was vaporized, resulting in consuming a thermal energy. On the other hand, since the heat-treated silica-based fiber sheet (C1) no longer had the hydroxyl groups, water was not generated and therefore the thermal energy consumption effect could not be obtained.

### [Effect of Lamination of Thermal Diffusion Layer (Preparation of Thermal Runaway Suppression Sheet)]

### 1. Thermal Diffusion Layer

An expanded graphite sheet (manufactured by Toyo Tanso Co., Ltd.) having a thickness of 0.2 mm and a bulk density of 0.8 g/cm³ was used as the thermal diffusion layer. The thermal conductivity (25° C.) of the expanded graphite sheet is 200 W/mK in the planar direction and 5 W/mK in the thickness direction.

### 2. Thermal Runaway Suppression Sheet No. 1

An expanded graphite sheet (GS) as a thermal diffusion layer was spray coated with an aerosol spray type synthetic rubber adhesive (“AP-2” from No Tape Industry Co., Ltd.) The synthetic rubber adhesive comprises styrene-butadiene rubber as a main component in a solid content of about 20% by weight, and a solvent (N-hexane and dimethyl ether). The silica-based fiber cloth (A1) (thickness 1.8 mm) as a fabric-type thermal energy consumption layer (A1) was superimposed on the coated surface of the expanded graphite sheet (GS) and then pressed to produce a thermal runaway suppression sheet.

### 3. Thermal Insulation Effect Part 1 by Lamination of Thermal Diffusion Layers

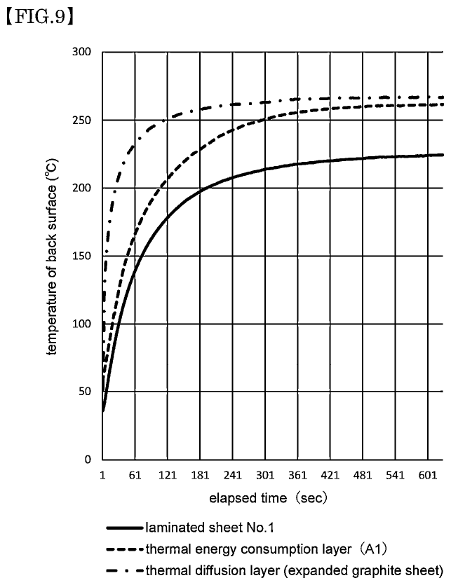

Regarding the thermal runaway suppression sheet No. 1 produced above (150 mm×150 mm), the change in temperature was measured in accordance with the above-mentioned measurement method 1 by monitoring for 5 minutes under the condition of 700° C. at the temperature of the upper surface of the electric furnace. For the reference, the change in temperature of the expanded graphite sheet (GS) and silica fiber cloth (A1) was individually measured. The measurement results are shown in FIG. 9.

In FIG. 9, the horizontal axis represents the elapsed time, and the vertical axis represents the temperature of back surface which is the surface opposite to the heated surface. The change in temperature of the silica fiber cloth A1 (thermal energy consumption layer) alone is indicated by a dashed line, the change in temperature of the expanded graphite sheet GS (thermal diffusion layer) alone is indicated by a long dashed dotted line, and the change in temperature of the thermal runaway suppression sheet No. 1 (layered structure) is indicated by a solid line.

As can be seen from FIG. 9, the temperature rise on the back surface of the silica fiber cloth (A1) alone was slower than that of the expanded graphite sheet (GS) alone. This is considered as the thermal energy consumption effect of the silica fiber cloth. Regarding the temperature of the stable state with no further rise in temperature observed on the back surface, the silica fiber cloth alone was around 260° C. while the expanded graphite sheet alone was around 265° C. They were not remarkably different from each other.

On the other hand, an exemplary thermal runaway suppression sheet No. 1, which was a combination of a silica fiber cloth and an expanded graphite sheet, exhibited a slower temperature rise, and reached a stable state around 245° C. with no further rise in temperature observed on the back surface. The temperature of the stable state in the usage of the thermal runaway suppressing sheet No. 1 was remarkably lowered as compared to the usage of the silica fiber cloth alone or the expanded graphite sheet alone. This is considered the synergistic effect of lamination of the thermal energy consumption layer and the thermal diffusion layer.

### 4. Fabrication of Thermal Runaway Suppression Sheet No. 2

Thermal runaway suppression sheet No. 2 (thickness: 1.6 mm) was fabricated in the same manner as No. 1, except that papermaking-type thermal energy consumption layer (B1) (thickness: 1.4 mm) was used in place of the fabric-type thermal energy consumption layer (A1). The thermal insulation performance was evaluated according to the measurement method 2. In addition, the change in temperature of the surface of the silica-based fiber sheet heated for 10 minutes (600 seconds) was measured. The average temperature of the surface in contact with the flame during the measurement was 1005° C.

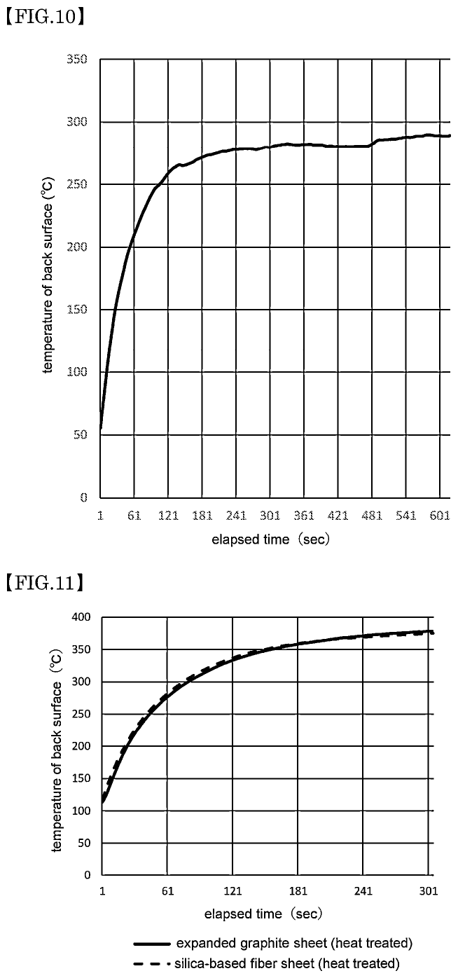

The measurement result is shown in FIG. 10.

The thermal runaway suppression sheet No. 2 containing a papermaking-type thermal energy consumption layer had a thickness as thin as 1.6 mm. The thermal runaway suppression sheet No. 2 could suppress to 300° C. or less at the back side of the sheet No. 2 that was exposed to a flame of 1000° C. for 10 minutes, as shown in FIG. 10.

### 5. Mode of Use and Insulation Effect

The silica-based fiber sheet and the expanded graphite sheet contained in the thermal runaway suppression sheet No. 1 were individually faced to the flame and the respective temperatures on the back side was measured according to the measurement method 1. The measurement was conducted by monitoring the change in temperature on the back side for 5 minutes (300 seconds) from immediately (1 second) after being placed on the top surface of the electric furnace set at 1000° C. The measurement results are shown in FIG. 11.

In FIG. 11, the measurement result of the case where the expanded graphite sheet was placed in contact with the upper surface of the electric furnace is indicated by a solid line, and that of the case where the silica-based fiber sheet was placed in contact with the upper surface of the electric furnace is indecated by a dashed line.

FIG. 11 shows that the temperature change in both cases were almost similar. Thus, almost the same level of thermal insulation effect could be obtained even if any side of the thermal runaway suppression sheet having an asymmetric layered structure is heated.

Therefore, in an application where a thermal runaway suppression sheet is placed between cells as shown in FIG. 1, there is no concern about which face of the the thermal runnaway suppression sheet is oriented toward either cell. This simplifies the assembly process involving the thermal runaway suppression sheet.

### [Kinds of Thermal Diffusion Layer and Thermal Diffusion Effect]

### 1. Kind of Thermal Diffusion Layer

An expanded graphite sheet (GS) or a boron nitride coating film (BN) was used as the thermal diffusion layer.

### 2. Preparation of Thermal Runaway Suppression Sheets No. 3 and No. 4

Thermal runaway suppression sheets No. 3 and No. 4 were prepared by spraying the boron nitride coating liquid onto the papermaking-type thermal energy consumption layer (B1) (150 mm×150 mm, 1.8 mm of thickness, and weight of 6.8g) to form a thermal diffusion layer composed of a boron nitride film. Thermal runaway suppression sheets No. 3 and No. 4 differing in the sprayed amount of the boron nitride coating liquid. The respective solid contents in the coating liquid sprayed were 1.1 g for No. 3 and 3.9 g for No. 4.

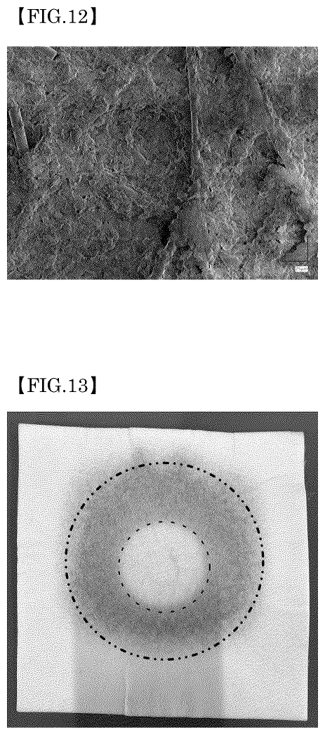

The coated surface of thermal runaway suppression sheet No. 4 was observed with a microscope. An obtained photograph (1000 in magnification) is shown in FIG. 12.

It can be recognized from FIG. 12 that a boron nitride film was formed in an interstice between the fibers.

Thermal runaway suppression sheets Nos. 2, 3, and 4 and the papermaking-type thermal energy consumption layer (B1) alone as a reference example were measured and evaluated based on the above-mentioned method for measuring and evaluating a thermal diffusion effect. Table 1 shows the results.

TABLE 1

| thermal runaway suppression sheet | | No.2 | No.3 | No.4 | reference |
|---|---|---|---|---|---|
| structure | thermal energy | papermaking- | papermaking- | papermaking- | papermaking- |
| | consumption layer | type B1 | type B1 | type B1 | type B1 |
| | thermal diffusion | graphite sheet | BN-coating | BN-coating | — |
| | layer | GS | film | film | |
| | thickness (mm) | 2.3 | 1.8 | 1.8 | 1.8 |
| | weight (g) | 11.8 | 7.9 | 10.7 | 6.8 |

| | | | | |
|---|---|---|---|---|
| temperature difference on back | 98.3 | 237.7 | 214.4 | 253.5 |
| surface (° C.) | | | | |

In Table 1, the temperature difference was calculated by the equation: [maximum temperature—minimum temperature], wherein the maximum temperature and minimum temperature are temperatures on the sheet surface. The smaller the temperature difference, the bigger the thermal diffusion effect.

The thermal runaway suppression sheets (Nos. 2, 3, and 4) of the invention in which a thermal diffusion layer was laminated on the thermal energy consumption layer (B1) had a smaller temperature difference than the thermal energy consumption layer (B1) alone as the reference example. This result was that the thermal energy caused from localized heat was diffused along the plane of the sheet.

The case of using a graphite sheet for the thermal diffusion layer (No. 2) was less than half that of the reference in the temperature difference. This result indicates that the graphite sheet can exert an excellent thermal diffusion effect.

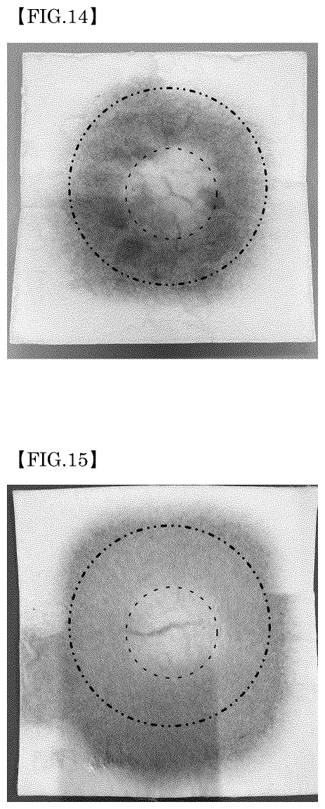

After the test, the heated surfaces of the thermal runaway suppression sheets Nos. 2 and 4 and the reference example were observed and photographed. The photographs of the papermaking-type thermal energy consumption layer alone (reference example), a sheet of the combination of the papermaking-type thermal energy consumption layer and a coating film of boron nitride as a thermal diffusion layer (No. 4), and a sheet of the combination of the papermaking-type thermal energy consumption layer and an expanded graphite sheet as a thermal diffusion layer (No. 2) are shown in FIG. 13, FIG. 14, and FIG. 15 respectively.

In FIG. 13, a portion surrounded by the dashed line was the area having a diameter of 40 mm that is correspondent to the heated portion. A portion surrounded by the long dashed double-dotted line was the area that was scorched due to burnt at a high temperature. The area surrounded by the long dashed double-dotted line turned into brown because the organic binder was burnt, whereas the area surrounded by the dashed line became white because the organic binder was burnt off.

In the same manner with FIG. 13, the area having a diameter of 40 mm corresponding to a heated area is surrounded by the dashed line, and the burnt area is surrounded by the long dashed double-dotted line in FIGS. 14 and 15.

In FIGS. 14 and 15, the burnt area was spread out from the area surrounded by the long dashed double-dotted line. This means that the released thermal energy affected wider area than the case that the silica-based fiber sheet alone was heated, in other words, the thermal diffusion layer distributed the thermal energy.

In addition, the extended area in FIG. 15 is larger than that in FIG. 14. This is coincided with the temperature difference shown in Table 1. Table 1 shows that No. 2 has a smaller temperature difference.

In addition, the sheets No. 3 and No. 4 had almost same average temperatures of 336° C. after 5 minutes from heating. Even if the thermal diffusion effect was enhanced by the increase in quantity of the coating film of boron nitride, the thermal insulation effect seems to be offset by reduction of inter-fiber gaps in the silica-based fiber sheet.

### [Relationship Between the Composition of the Papermaking-Type Thermal Energy Consumption Layer, Thermal Insulation Properties, and Strength]

### <Ingredients in the Slurry for Papermaking>

### (1) Silica-Based Inorganic Fiber

Chopped strand (fiber diameter of 9 μm, fiber length of 1 to 5 mm) of BELCOTEX (registered trademark) 110 (composition: AlO_{1.5}·18[(SiO₂)_{0.6} (SiO_{1.5}OH)_{0.4}]) from BELCHEM GmbH was used without heat treatment, hereinafter called as “silica-based inorganic fiber without heat treatment”.

### (2) Fibrous Minerals

### Sepiolite

Sepiolite having an average primary particle size of 30 to 70 μm and a bulk specific gravity of 0.13 to 0.15 g/ml was used.

### Potassium Titanate

Tismo manufactured by Otsuka Chemical Co., Ltd., which is potassium titanate (whisker) having a fiber diameter of 0.3 to 0.6 μm and a fiber length of 10 to 20 μm was used.

### (3) Glass Fiber

E-glass fiber with a diameter of 5 to 9 μm and a length of 3 to 9 mm was used.

### (4) Organic Binder

Pulp fiber or polyester fiber, each of which has a diameter of 20 to 30 μm, was used.

### <Preparation of Slurry for Papermaking and Production of Sheet by Papermaking Method>

In a container containing 2000 cc of water, the ingredients were blended at the ratio in the slurry shown in Table 2, mixed and stirred using a mixer, and then made into paper using a handcomb.

A wet sheet obtained by papermaking was placed in an oven and dried at 100° C. for 10 minutes. Thus, a sheet (150 mm×150 mm) having a thickness of 1.5 mm was obtained.

The sheet was subjected to the thermal insulation measurement method 3, and was measured and evaluated with respect to thermal insulation, heat shrinkage resistance, and properties after combustion. The measurement results are shown in Table 2.

A mica sheet (commercial product) as a reference example was evaluated in the same manner and the result is shown in Table 2.

TABLE 2

| | composition of slurry (weight part) | | | | | | evaluation | | |
|---|---|---|---|---|---|---|---|---|---|
| | silica- | | | | | | back surface | heat | |
| | based | | glass | potassium | | | temperature | shrinkage | bulk density |
| No | fiber | sepiolite | fiber | titanate | pulp fiber | PET fiber | (° C.) | resistance | Kg/m³ |
| B2 | without | 0 | 0 | 0 | 0 | 2 | 352 | crack | 181 |
| | heat | | | | | | | occurred | |
| | treatment | | | | | | | | |
| | 98 | | | | | | | | |
| B3 | without | 0 | 15 | 15 | 7 | 0 | 337 | no crack | 189 |
| | heat | | | | | | | | |
| | treatment | | | | | | | | |
| | 63 | | | | | | | | |
| C2 | 0 | 80 | 10 | 0 | 10 | 0 | 368 | no crack | 447 |
| C3 | 0 | 0 | 90 | 0 | 10 | 0 | 452 | surface | 183 |
| | | | | | | | | molten | |

| | | | | |
|---|---|---|---|---|
| reference | mica sheet (commercial product) | 413 | no crack | 2200 |

Sheets (132, 133) using untreated silica-based fibers were expected to exhibit a thermal energy consumption effect through dehydration condensation reaction at a high temperature. The back surface temperature was relatively lower owing to the thermal insulating effect. This thermal insulation effect was superior to that of a mica sheet (reference example) which has been already practically used for a thermal runaway suppression sheet.

However, B2 sheet, which did not contain glass fiber or fibrous mineral, could not follow its shrinkage due to the dehydration condensation reaction caused by heating. The shrunk sheet could not entirely adhere to the steel plate 17, as a result, the crack occurred in the sheet.

C2 was a sheet containing a fibrous mineral as a main ingredient and glass fiber but not containing silica-based fiber. No cracks were observed in the sheet after the flame exposure test, which means a serious shrinkage was not caused by dehydration condensation reaction. However, the effect of consuming thermal energy was not obtained in C2, which was inferior to the silica-based fiber sheets B2 and B3 in thermal insulation.

C3 is a sheet containing glass fiber as a main ingredient. Since the glass fiber was molten at 1000° C. as a temperature of the flame, a satisfactory thermal insulation could not be obtained. The molten glass fiber was confirmed by the observation of the surface of C3 after the test, because the glass fiber no longer had a fibrous form in the area exposed to the flame and its surroundings.

Although the mica sheet (reference example) has been practically used as a thermal runaway suppression sheet, the bulk density is remarkably higher than the papermaking-type sheet (C3) whose main component is mineral fiber. The mica sheet has been required for improvement in terms of weight.

### INDUSTRIAL APPLICABILITY

When one cell in a battery pack is locally increased in temperature, a thermal runaway suppression sheet of the invention suppresses the temperature rise of adjacent battery cells by attenuating thermal energy released from the locally heated cell. Moreover, placing the thermal runaway suppression sheet between a battery cell and a housing enables to suppress the influence of a thermally runaway battery module on another battery module in which a plurality of batteries are stacked. Therefore, it is useful for preventing the propagation of thermal runaway of the trigger cell in a battery, battery module, and battery pack.

### DESCRIPTION OF CODE

1, 1′ battery cell
2 housing
3, 4 thermal runaway suppression sheet

1. A thermal runaway suppression sheet comprising a thermal energy consumption layer and a thermal diffusion layer,
wherein the thermal energy consumption layer is a silica-based inorganic fiber sheet comprising a silica-based inorganic fiber having a hydroxyl group;
wherein the thermal diffusion layer has a thermal conductivity in its planar direction from 10 to 200 times in its thickness direction; and
wherein the thermal runaway suppression sheet has a thickness of 3 mm or less.

2. The thermal runaway suppression sheet according to claim 1, wherein the silica-based inorganic fiber sheet is a woven fabric, nonwoven fabric, or paper each having a thickness of 0.1 to 2.0 mm.

3. The thermal runaway suppression sheet according to claim 2, wherein the silica-based inorganic fiber sheet is obtained by forming the silica-based inorganic fiber staple fiber into a sheet having a thickness of 0.1 to 1.5 mm.

4. The thermal runaway suppression sheet according to claim 3, wherein a content of the silica-based inorganic fiber contained in the silica-based inorganic fiber sheet is from 100 kg/m³ to 400 kg/m³.

5. The thermal runaway suppression sheet according to claim 3, wherein the silica-based inorganic fiber sheet is a nonwoven fabric or paper containing the silica-based inorganic fiber of 50 to 80% by weight, a glass fiber of 2 to 20% by weight, and an organic fiber of 3 to 15% by weight.

6. The thermal runaway suppression sheet according to claim 5, further comprising a fibrous mineral.

7. The thermal runaway suppression sheet according to claim 1, wherein the thermal energy consumption layer has a bulk density of 150 to 400 kg/m³.

8. The thermal runaway suppression sheet according to claim 1, wherein the thermal diffusion layer is a sheet containing expanded graphite or boron nitride as a main component.

9. The thermal runaway suppression sheet according to claim 1, wherein the thermal diffusion layer is a boron nitride film.

10. A silica-based inorganic fiber sheet comprising from 50 to 80% by weight of dehydration-condensable silica-based inorganic fiber, from 2 to 20% by weight of glass fiber, from 3 to 15% by weight of organic fiber, and optionally from 10 to 40% by weight of a fibrous mineral.

11. The silica-based inorganic fiber sheet according to claim 10, wherein the fibrous mineral is at least one selected from the group comprising sepiolite, palygorskite, potassium titanate whisker, and wollastonite.

12. A battery pack or a battery module in which battery cells are connected in series or in parallel and stored in a housing, comprising
a plurality of battery cells,
a thermal runaway suppression sheet having a thickness of 3 mm or less, the thermal suppression sheet being interposed between the battery cells, or being attached to the inner wall surface of the housing with which the battery cells are in contact,
wherein the thermal runaway suppression sheet comprises a thermal energy consumption layer and a thermal diffusion layer, wherein the thermal energy consumption layer is a silica-based inorganic fiber sheet comprising a silica-based inorganic fiber having a hydroxyl group and wherein the thermal diffusion layer has a thermal conductivity in its planar direction from 10 to 200 times in its thickness direction.
